(19) United States
(12) Patent Application Publication
(10) Pub. No.: US 2025/0300532 A1
(43) Pub. Date: Sep. 25, 2025

(54) MANUFACTURING APPARATUS AND MANUFACTURING METHOD FOR HAIRPIN CONDUCTOR

(71) Applicants: AMADA CO., LTD., Kanagawa (JP); AMADA PRESS SYSTEM CO., LTD., Kanagawa (JP)

(72) Inventors: Takehito YAMAGUCHI, Kanagawa (JP); Yutaka SATOU, Kanagawa (JP)

(73) Assignees: AMADA CO., LTD., Kanagawa (JP); AMADA PRESS SYSTEM CO., LTD., Kanagawa (JP)

(21) Appl. No.: 18/869,312

(22) PCT Filed: May 30, 2023
(86) PCT No.: PCT/JP2023/020113

§ 371 Date: Nov. 26, 2024

(30) Foreign Application Priority Data
Jun. 7, 2022 (JP) 2022-092381

(51) Int. Cl. H02K 15/0421; B21F 1/00

(52) U.S. Cl. CPC H02K 15/0421; B21F 1/00

(57) ABSTRACT

A manufacturing apparatus for a hairpin conductor includes: an index table configured to intermittently rotate around a rotation axis; a plurality of grippers attached to the index table at an angle pitch, the grippers each being configured to be capable of gripping a linear cut wire in a radially extending horizontal position; and a plurality of station apparatuses installed around the index table at an angle pitch, the station apparatuses being configured to process the cut wire, gripped by the gripper, in stages to shape the cut wire into a three-dimensional hairpin conductor. The plurality of station apparatuses include bending apparatuses and a pressing apparatus, and has an installation order set along a rotation direction of the index table.

### TECHNICAL FIELD

The present disclosure relates to a manufacturing apparatus and a manufacturing method for a hairpin conductor.

### BACKGROUND ART

As a coil constituting a motor stator, a segment coil is known in which a plurality of substantially U-shaped divided conductors (hereinafter referred to as hairpin conductors) made of rectangular wire are connected to form a coil.

Patent Literatures 1 and 2 describe a manufacturing method for hairpin conductor. A manufacturing method for a hairpin conductor described in Patent Literature 1 includes: bending a front end portion of a linear conductor material to shape it into a predetermined two-dimensional shape; and clamping and shaping the two-dimensionally shaped portion with a tool to shape it into a three-dimensional shape, and then cutting it to a predetermined length to form a hairpin conductor. In a manufacturing method for a hairpin conductor described in Patent Literature 2, a plurality of processes of bending a linear conductor material to form it into a predetermined two-dimensional shape are performed at one station. Patent Literature 3 describes an apparatus and method for manufacturing a member equivalent to a hairpin conductor, called a hairpin element. The manufacturing apparatus and manufacturing method for a hairpin conductor described in

Patent Literature 3 includes: disposing a plurality of bending apparatuses in a straight line; and sequentially bending a linear blank wire with the plurality of bending apparatuses on the straight line to form a hairpin-shaped hairpin conductor.

### CITATION LIST

### Patent Literature

[Patent Literature 1] Japanese Patent Application Laid-Open Publication No. 2003-143818

[Patent Literature 2] Japanese Patent Application Laid-Open Publication No. 2019-033554

[Patent Literature 3] German Patent Application Publication No. 102018221152

### SUMMARY OF INVENTION

The manufacturing method for the hairpin conductor described in Patent Literature 1 includes: subjecting a linear conductor material to two-dimensional processing by bending, and three-dimensional processing by clamping with tools; and then cutting the conductor material to a predetermined length for a single hairpin conductor. Therefore, two-dimensional processing of the next hairpin conductor cannot be started before the ends of the two-dimensional and three-dimensional processing and the completion of the cutting for shaping one hairpin conductor. The manufacturing method for a hairpin conductor described in Patent Literature 2 includes subjecting a linear conductor material to a plurality of two-dimensional processing by bending, at one station. Therefore, two-dimensional processing of the next hairpin conductor cannot be started before completion of a plurality of processing at one station. The manufacturing method with a manufacturing apparatus for a hairpin conductor described in Patent Literature 3 requires re-gripping every time the workpiece is sent to an adjacent bending machine that performs the next bending. Therefore, the manufacturing methods for the hairpin conductor described in Patent Literatures 1 to 3 have room for improvement in terms of difficulties in shortening the takt time.

To solve the above problem, one aspect of the present disclosure includes the following configuration 1) and procedure 2).
1) A manufacturing apparatus for a hairpin conductor including:
   an index table configured to intermittently rotate around a perpendicularly extending rotation axis;
   a plurality of grippers attached to the index table at a predetermined angle pitch around the rotation axis, the grippers each being configured to be capable of gripping a linear cut wire in a radially extending horizontal position, the linear cut wire having a predetermined length; and
   a plurality of station apparatuses installed around the index table at the angle pitch around the rotation axis, the station apparatuses being configured to process the cut wire, gripped by the grippers, in stages to shape the cut wire into a hairpin conductor having a three-dimensional shape,
   wherein the plurality of station apparatuses include a bending apparatus and a pressing apparatus, and an installation order is set along a rotation direction of the index table.
2) A manufacturing method for a hairpin conductor, including:
   disposing a bending apparatus and a pressing apparatus around an index table at a predetermined angle pitch along a rotation direction of the index table, the bending apparatus and the pressing apparatus being configured to process a rectangular wire in stages into a hairpin conductor having a three-dimensional shape, the index table being configured to intermittently rotate;
   gripping, e of a plurality of grippers, a linear cut wire having a predetermined length in a radially extending horizontal position, the grippers being attached to the index table at the angle pitch;
   performing, by the bending apparatus, two-dimensional bending of the cut wire gripped by the grippers in a stop period of intermittent rotation of the index table; and
   shaping, by the pressing apparatus, the cut wire into the hairpin conductor having a three-dimensional shape in a next stop period, the cut wire having been subjected to the bending.

According to one aspect of the present disclosure, an effect is obtained in which hairpin conductors can be produced in a short takt time.

### BRIEF DESCRIPTION OF DRAWINGS

FIG. 1 is a diagram showing a manufacturing system ST including an implementation example of a manufacturing apparatus for a hairpin conductor according to an embodiment of the present disclosure.

FIG. 2A is a diagram showing a partially-stripped wire Wb stripped by a stripping apparatus 83 of the manufacturing system ST, with FIG. 2A (a) being a plan view and FIG. 2A (b) being a side view.

FIG. 2B is a cross-sectional view taken at a position 2B-2B in FIG. 2A (a).

FIG. 2C is a diagram showing a cut wire Wc cut by a feed cutting apparatus 84 of the manufacturing system ST.

FIG. 3 is a top view showing an index table 71 of a wire processing apparatus 91 in the manufacturing system ST.

FIG. 4 is a top view showing a first station apparatus 1 in the wire processing apparatus 91.

FIG. 5 is a side view of the first station apparatus 1.

FIG. 6A is a top view showing a first stage in a process of the first station apparatus 1.

FIG. 6B is a top view showing a second stage in the process of the first station apparatus 1.

FIG. 6C is a top view showing a third stage in the process of the first station apparatus 1.

FIG. 6D is a top view showing a fourth stage in the process of the first station apparatus 1.

FIG. 7 is a top view showing a process of a second station apparatus 2.

FIG. 8A is a top view showing a process of a third station apparatus 3.

FIG. 8B is a plan view showing a bent wire Wf after processing in the third station apparatus 3.

FIG. 9A is a diagram showing pressing in a fourth station apparatus 4.

FIG. 9B is a plan view showing a hairpin conductor Wg obtained by processing in the fourth station apparatus 4.

FIG. 9C is a diagram showing a deformation of an arm portion Wm1 of the bent wire Wf in processing in the fourth station apparatus 4.

FIG. 9D is a diagram showing operation corresponding to deformation of the arm portion Wm1.

FIG. 9E is a side view of the fourth station apparatus 4.

FIG. 10 is a diagram showing operation of a fifth station apparatus 5.

FIG. 11 is a block diagram of the wire processing apparatus 91.

FIG. 12 is a block diagram of the first to third station apparatuses 1 to 3.

FIG. 13 is a block diagram of the fourth station apparatus 4.

### DESCRIPTION OF EMBODIMENT

### Implementation Example

An implementation example of a manufacturing apparatus for a hairpin conductor according to an embodiment of the present disclosure is a wire processing apparatus 91.

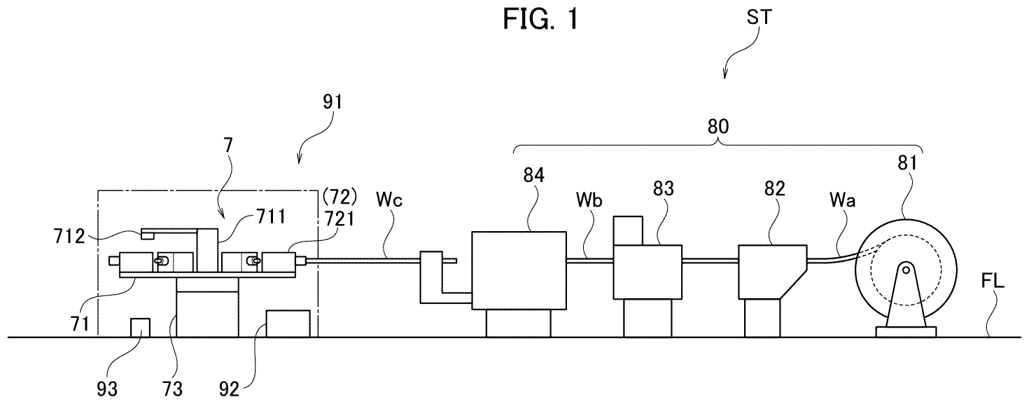

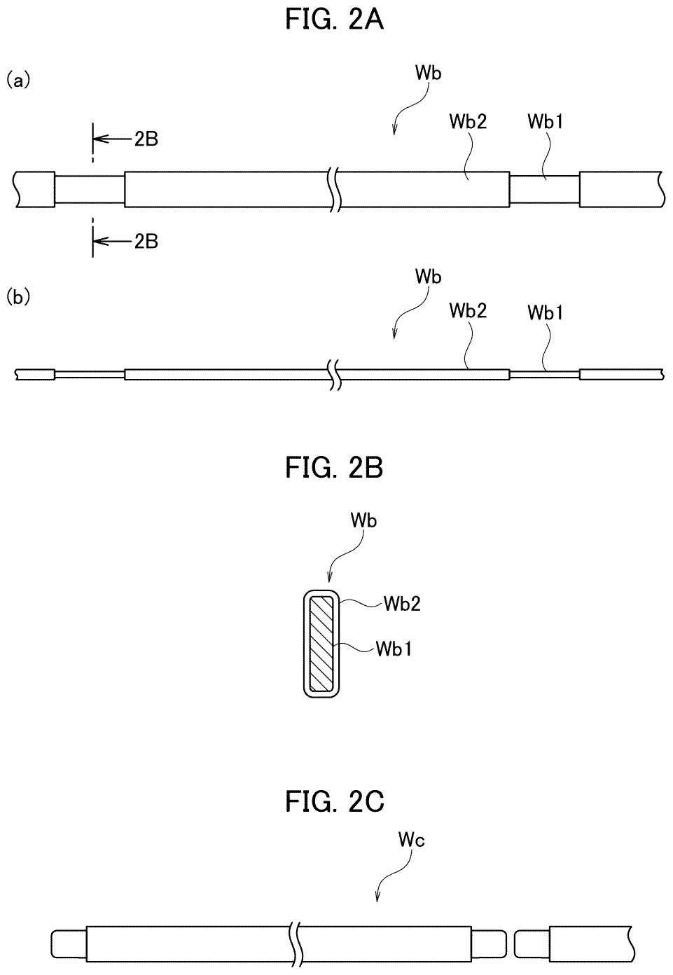

FIG. 1 is a diagram showing a manufacturing system ST including an implementation example of a manufacturing apparatus for a hairpin conductor according to an embodiment of the present disclosure. FIG. 2A is a diagram showing a partially-stripped wire Wb stripped by a stripping apparatus 83 of the manufacturing system ST, in which FIG. 2A (a) is a plan view and FIG. 2A (b) is a side view. FIG. 2B is a cross-sectional view taken at a position 2B-2B in FIG. 2A. FIG. 2C is a diagram showing a cut wire Wc cut by a feed cutting apparatus 84 of the manufacturing system ST.

The manufacturing system ST shown in FIG. 1 is a system for continuously manufacturing hairpin conductors from rectangular wire, and includes a pre-processing apparatus group 80 and a wire processing apparatus 91. A hairpin conductor is a conductor formed by bending and pressing a rectangular wire into a hairpin shape. A hairpin coil is formed by connecting a plurality of hairpin conductors. Hairpin coils are used in automobile drive and regenerative motors, etc. In the manufacturing system ST, the pre-processing apparatus group 80 includes, from the upstream side of the processes, an uncoiler 81, a wire straightening machine (straightener) 82, a stripping apparatus 83, and a feed cutting apparatus 84.

A rectangular wire is wound around the uncoiler 81. The wire straightening machine 82 straightens the rectangular wire Wa sent out from the uncoiler 81 with its position flat in the up-down direction, that the rectangular wire Wa is straightened and sent out. The stripping apparatus 83 strips the rectangular wire Wa sent out from the wire straightening machine 82 of its coating Wb2 over a predetermined length range, by pressing or another processing method. The stripping apparatus 83 causes the rectangular wire Wa to be made into a partially-stripped wire Wb repeatedly having core-exposed portions Wb1 at a predetermined pitch, as shown in FIG. 2. Each core-exposed portion is a portion in which the core wire is exposed over a predetermined length range. The stripping apparatus 83 then sends out the partially-stripped wire Wb. FIG. 2B is a cross-sectional view of the partially-stripped wire Wb in the core-exposed portion Wb1. The corners of the core-exposed portion Wb1 may be chamfered.

As shown in FIG. 2C, the feed cutting apparatus 84 cuts the partially-stripped wire Wb, which has been sent out from the stripping apparatus 83, at the central position of the core-exposed portion Wb1 in the longitudinal direction to make the wire Wb into a cut wire Wc. The feed cutting apparatus 84 then sends out the cut wire Wc in sequence to the wire processing apparatus 91.

The wire processing apparatus 91 is installed downstream of the pre-processing apparatus group 80. The wire processing apparatus 91 includes an index unit 7, a discharge unit 92, and a control unit 93, and the like. The index unit 7 includes a base unit 73 installed on the floor FL, an index table 71, a support column 711, and a camera 712. The index table 71 is equipped with a group of grippers 72 including a gripper 721 that grips the cut wire Wc sent out from the feed cutting apparatus 84.

### Wire Processing Apparatus 91

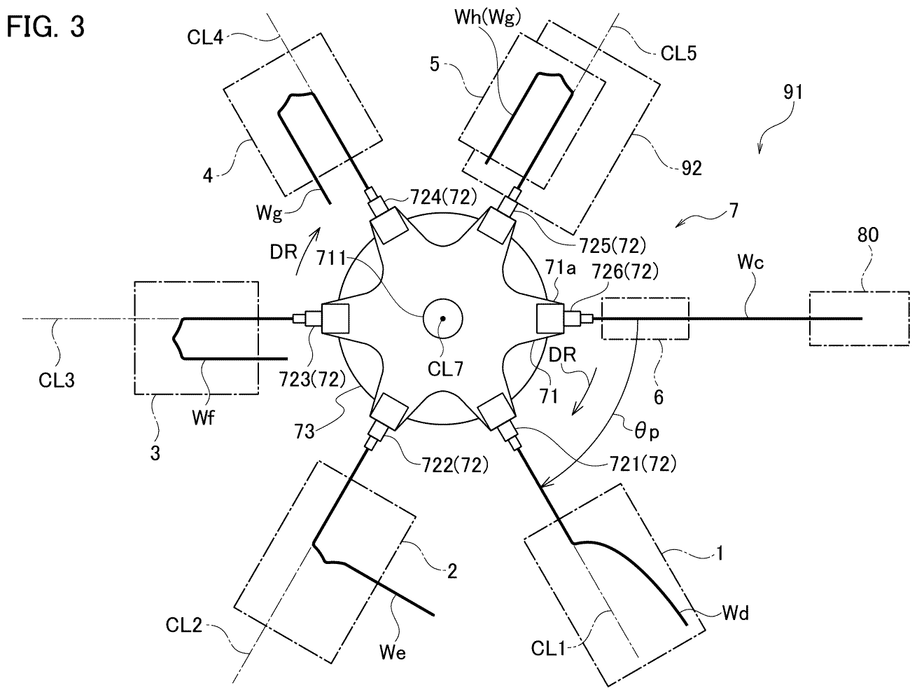

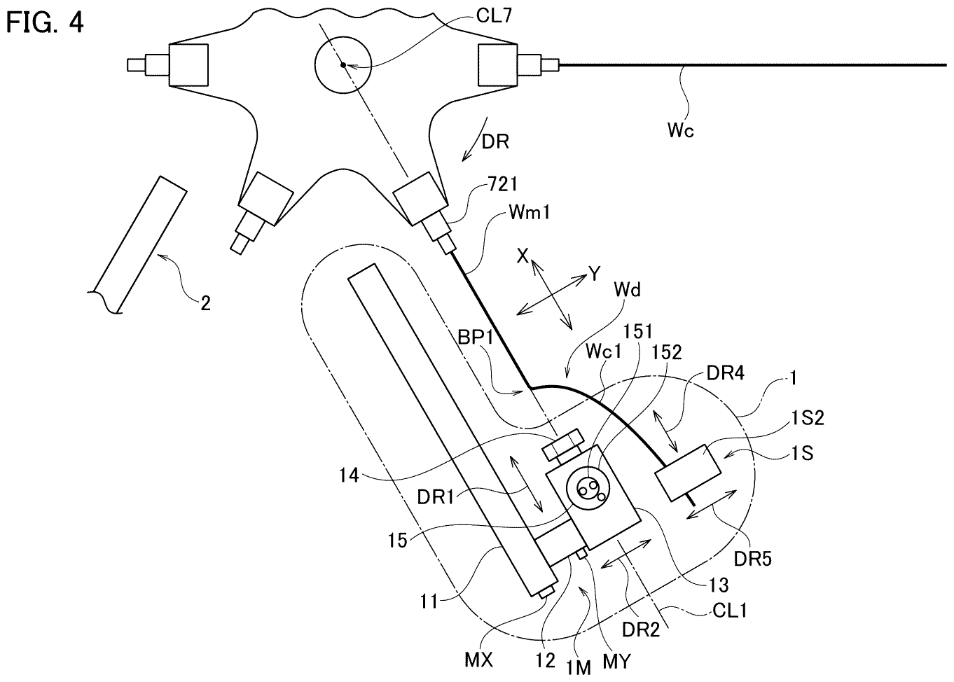

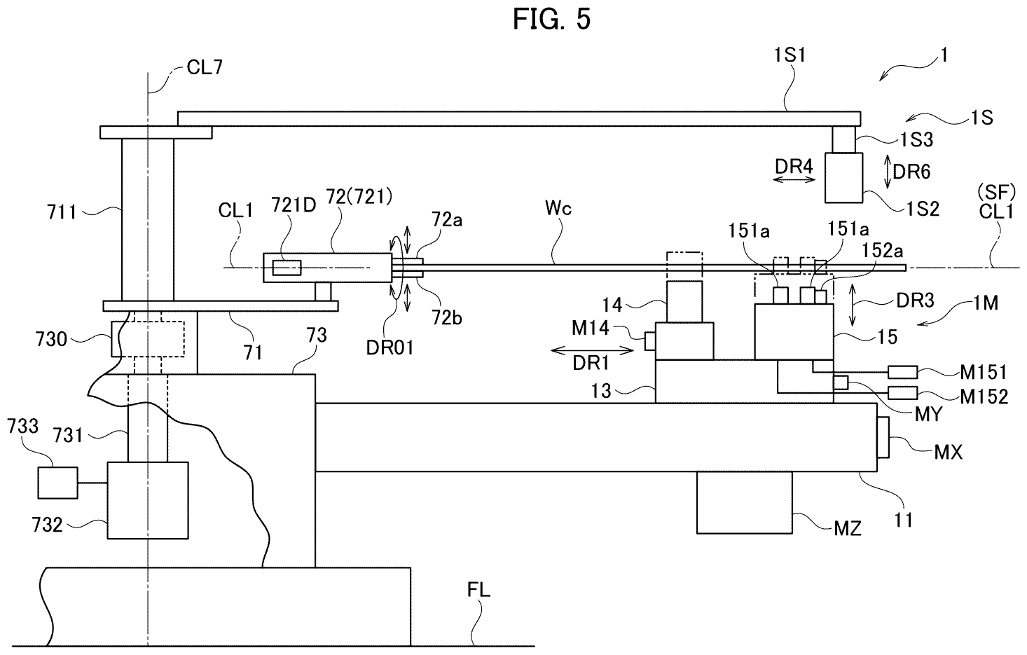

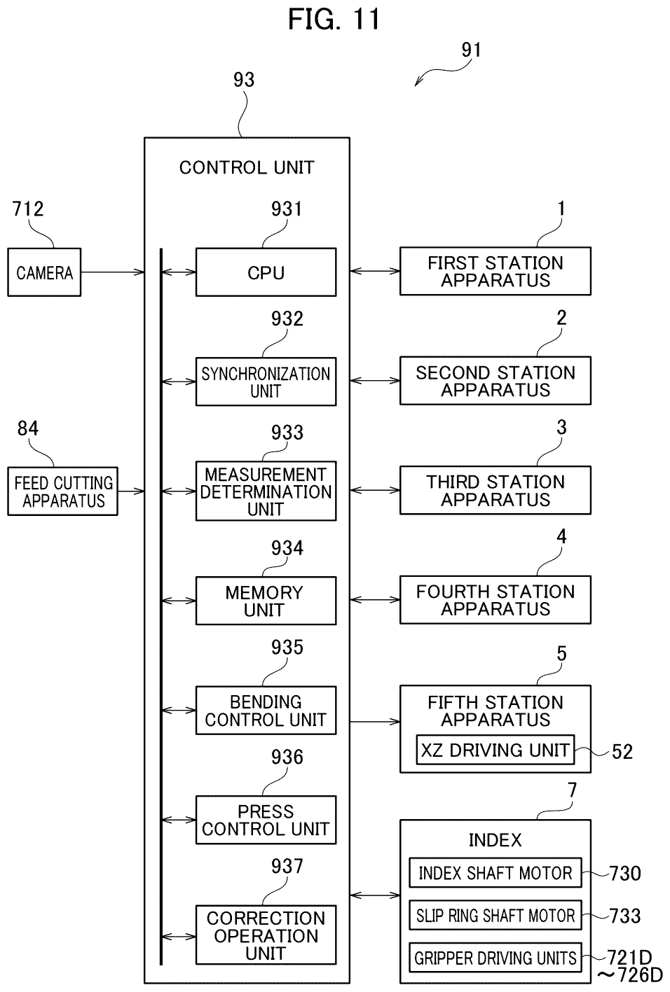

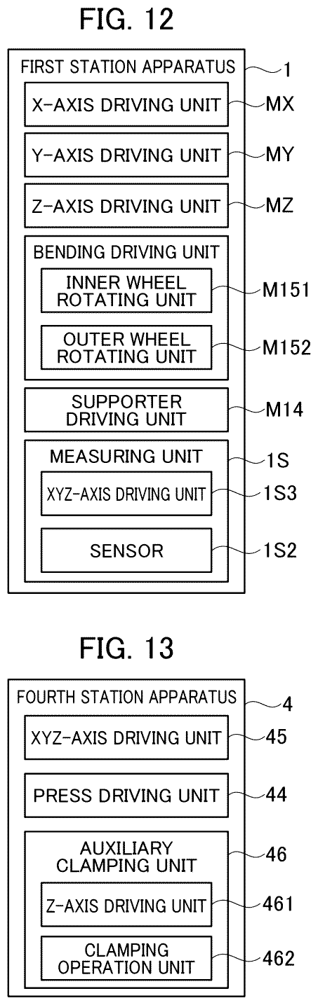

Next, the detailed configuration of the wire processing apparatus 91 will be described with reference to FIGS. 3 to 5 and FIGS. 11 to 13. FIG. 3 is a top view showing the index table 71 of the wire processing apparatus 91 in the manufacturing system ST. FIG. 4 is a top view showing the first station apparatus 1 in the wire processing apparatus 91. FIG. 5 is a side view of the first station apparatus 1. FIG. 11 is a block diagram of the wire processing apparatus 91. FIG. 12 is a block diagram of the first to third station apparatuses 1 to 3. FIG. 13 is a block diagram of the fourth station apparatus 4.

As shown in FIG. 3 and FIG. 5, the wire processing apparatus 91 includes the base unit 73, the index table 71, and the first to fifth station apparatuses 1 to 5. As shown in FIG. 5, inside the base unit 73 installed on the floor FL, an index shaft motor 730, a shaft 731, a slip ring 732, and a slip ring shaft motor 733 are installed with a perpendicularly extending rotation axis CL7 as the axis center. As shown in FIG. 11, the operation of the index shaft motor 730 and the slip ring shaft motor 733 is controlled by a control unit 93.

A flat index table 71 is disposed in a horizontal position above the base unit 73. The index table 71 is connected to the output shaft of the index shaft motor 730 and rotates around the rotation axis CL7 with the operation of the index shaft motor 730. As shown in FIG. 3, the index table 71 includes six protruding portions 71a that protrude radially outward at a predetermined angle pitch θp in the circumferential direction. In this example, the predetermined angle pitch θp is 60°. The upper surfaces of the six protruding portions 71a respectively have grippers 721 to 726 attached thereto. The grippers 721 to 726 are collectively referred to as a group of grippers 72.

The grippers 721 to 726 each include a pair of gripping jaws 72a and 72b (see FIG. 5). The pairs of gripping jaws 72a and 72b are respectively operated by gripper driving units 721D to 726D respectively provided on the grippers 721 to 726 so that each pair of gripping jaws 72a and 72b come into contact with each other from separate position and are thereby able to grip the cut wire Wc. The pair of gripping jaws 72a and 72b are also configured to rotate around the clamping axis CL1 (see an arrow DR01).

Specifically, in FIG. 5, when a virtual clamping axis CL1 is assumed that corresponds to the protruding portion 71a, passes across the rotation axis CL7, and extends horizontally in the radial direction, the gripper 721 is configured to be able to: grip the cut wire Wc placed so as to extend on the clamping axis CL1; and rotate (that is, be rotatable) in a manner equivalent to twisting around the clamping axis CL1. The clamping axis CL1 coincides with the central axis of the cut wire Wc gripped by the gripper 721. The same applies to the grippers 722 to 726 and their corresponding clamping axes CL2 to CL6. The gripping jaws 72a and 72b of the grippers 721 to 726 is caused to operate and rotate around the clamping axis CL1 by the gripper driving units 721D to 726D. As shown in FIG. 11, the operation of the gripper driving units 721D to 726D is controlled by the control unit 93.

The control unit 93 controls the index shaft motor 730 to operate to intermittently rotate the index table 71 around the rotation axis CL7 at a predetermined angle pitch θp. In this example, the angle pitch θp is 60°. The electrical connections between the control unit 93 and the gripper driving units 721D to 726D are made via the slip ring 732 because the index table 71 including the gripper driving units 721D to 726D rotates intermittently relative to the base unit 73 (see FIG. 5). In this example, the slip ring shaft motor 733 is used that rotates the shaft of the slip ring 732, to synchronize the rotation of the shaft of the slip ring 732 with the rotation of the shaft of the index table 71 under the control of the control unit 93. This prevents the cables from the gripper driving units 721D to 726D from twisting due to the intermittent rotation.

The index table 71 of the index unit 7 shown in FIG. 3 is shown in a state in which the index table 71 stops in the intermittent rotation. In this state, the positions corresponding to the six protruding portions 71a are one supply position and five station positions. In detail, in FIG. 3, the position corresponding to the gripper 726 is the supply position, and the positions corresponding to the grippers 721 to 725 are respectively the first to fifth station positions. The first to fifth station apparatuses 1 to 5 are installed at the first to fifth station positions, respectively.

At the supply position, the cut wire Wc is sent out from the pre-processing apparatus group 80 toward the index unit 7, and the gripper 726 grips the cut wire Wc. The control unit 93 rotates the index table 71 intermittently at a predetermined time interval and stop time in clockwise direction in FIG. 3 (see an arrow DR). Within the stop time of the intermittent rotation, processing and the like are performed by the first to fifth station apparatuses 1 to 5 on the workpieces that are respectively gripped by the grippers 721 to 725.

Each time the index table 71 stops in the intermittent rotation, the gripper 726 at the supply position grips the cut wire Wc supplied from the pre-processing apparatus group 80 side. In other words, the gripping states of the grippers 721 to 726 shown in FIG. 3 is indicated in a state when the workpiece gripped at the first station position has rotated to the fifth station position through five times of intermittent operation.

The wire processing apparatus 91 described above performs the following operation described in outline under the control of the control unit 93. The first station apparatus 1 to the third station apparatus 3 are bending apparatuses with the same configuration, and each of them bends a workpiece two-dimensionally in a horizontal plane. In FIG. 3, the cut wire Wc, which has been gripped by the gripper 726 and moved by intermittent rotation from the sixth station position (supply position) to the first station position, is two-dimensionally bent by the first station apparatus 1 to form a bent wire Wd. The bent wire Wd is sent to the second station position by the next intermittent rotation while being gripped by the gripper 726, and is two-dimensionally bent by the second station apparatus 2 to form a bent wire We. The bent wire We is sent to the third station position by the next intermittent rotation while being gripped by the gripper 726, and is two-dimensionally bent by the third station apparatus 3 to form a bent wire Wf.

The fourth station apparatus 4 subjects the workpiece to three-dimensional pressing including deformation in the perpendicular direction. When the bent wire Wf is sent to the fourth station position by the next intermittent operation, it is pressed by the fourth station apparatus 4 to be shaped into a hairpin conductor Wg having a three-dimensional-shape.

The fifth station apparatus 5 determines whether or not the hairpin conductor Wg has been shaped into a predetermined shape, and performs correction processing when the hairpin conductor Wg is determined not to have been shaped into a predetermined shape. When the hairpin conductor Wg obtained by the fourth station apparatus 4 is determined to be a non-defective product by the fifth station apparatus 5, the gripper 725 releases its grip and discharges the hairpin conductor Wg to the discharge unit 92. When the hairpin conductor Wg is determined to be defective, correction bending is performed according to the nature of the defect to form a hairpin conductor Wh. Then, determines when the remeasurement that hairpin conductor Wh is a non-defective product, the gripper 725 releases its grip and discharges the hairpin conductor Wh to the discharge unit 92 as a non-defective product. When the remeasurement determines that the hairpin conductor Wh is a defective product, the hairpin conductor Wh is classified separately from the non-defective products and discharged to the discharge unit 92.

As shown in FIG. 11, the control unit 93 includes a CPU (central processing unit) 931, a synchronization unit 932, a measurement determination unit 933, a memory unit 934, a bending control unit 935, a press control unit 936, and a correction operation unit 937. The synchronization unit 932 synchronizes the operation of the pre-processing apparatus group 80 with the operation of the wire processing apparatus 91, and synchronizes the intermittent operation of the index table 71 in the wire processing apparatus 91 with the processing operation of the first to fifth station apparatuses 1 to 5. The measurement determination unit 933 determines whether or not correction processing has been performed at the fifth station position based on the image from the camera 712. In addition, the measurement determination unit 933 issues an instruction to stop the bending operation of the first to third station apparatuses 1 to 3 based on the detection signal from the sensor 1S2. The memory unit 934 stores the shape of the hairpin conductor to be processed from the workpiece, and the dimension range for determining that the hairpin conductor is a non-defective product. The bending control unit 935 controls the two-dimensional bending operation of the first to third station apparatuses 1 to 3. The press control unit 936 controls the three-dimensional bending operation of fourth the station apparatus 4. The correction operation unit 937 controls the correction operation of the correction unit 51 of the fifth station apparatus 5.

Next, the detailed structure and specific operation of the first to fifth station apparatuses 1 to 5 will be described. Since the structures of the first to third station apparatuses 1 to 3 are substantially the same, the first station apparatus 1 will be described as a representative. In the following description, the direction parallel to each of the clamping axes CL1 to CL6 is defined as an X-axis direction, and the direction perpendicular to the X-axis direction in the horizontal plane is defined as a Y-axis direction. The perpendicular direction perpendicular to the X-axis and Y-axis directions is defined as a Z-axis direction.

As shown in FIGS. 4 and 5, the first station apparatus 1 includes a processing unit 1M and a measuring unit 1S.

### Processing Unit 1M

The processing unit 1M includes an X-axis arm 11, a Y-axis arm 12, a base unit 13, a supporter 14, and a two-axis rotation unit 15. The X-axis arm 11 is disposed on the rotation direction (arrow DR direction) side of the index table 71 relative to the clamping axis CL1. The X-axis arm 11 is a rail-shaped member extending parallel to the clamping axis CL1 below the clamping axis CL1. The Y-axis arm 12 is an arm extending in the Y-axis direction and is supported by the X-axis arm 11 so as to be movable in the X-axis direction (see the arrow DR1). The Y-axis arm 12 moves in the X-axis direction by operation of an X-axis driving unit MX.

The base unit 13 is supported by the Y-axis arm 12 so as to be movable in the Y-axis direction (see an arrow DR2). The base unit 13 moves in the Y-axis direction by operation of a Y-axis driving unit MY. The base unit 13 can be moved in the Z-axis direction by a Z-axis driving unit MZ (see an arrow DR3). This causes the base unit 13 to be movable in three axis directions: X, Y, and Z.

As shown in FIG. 5, the supporter 14 and the two-axis rotation unit 15 are disposed on the upper part of the base unit 13. The supporter 14 is configured to be able to clamp and hold the cut wire Wc in its width direction (Y-axis direction) by operation of a supporter driving unit M14, the cut wire Wc being gripped by the gripper 721 and extending on the clamping axis CL1.

The two-axis rotation unit 15 includes an inner rotation unit 151 and an outer rotation unit 152 with a larger diameter than the inner rotation unit 151, which rotate independently and are concentric. The inner rotation unit 151 includes a pair of inner pins 151a that protrude upward and are positioned 180° apart as viewed from above. The inner rotation unit 151 rotates to any rotation angle in any rotation direction by operation of an inner wheel driving unit M151. The internal distance between the pair of inner pins 151a is larger than the width of the cut wire Wc. The outer rotation unit 152 includes an outer pin 152a that protrudes upward. The outer rotation unit 152 rotates to any rotation angle in any rotation direction by operation of an outer wheel driving unit M152. The base unit 13 moves up and down by operation of the Z-axis driving unit MZ (see the arrow DR3).

In other words, a solid line and a dash-dot line in FIG. 5 respectively indicate the lower end portion and upper end position of movement of the supporter 14 and the two-axis rotation unit 15. The supporter 14 and the two-axis rotation unit 15 move up and down between an upper position and a lower position. The upper position is a position where the supporter 14 and the two-axis rotation unit 15 interfere with the rectangular wire (cutting wire Wc), gripped by the gripper 721, in the height direction. The lower position is a position where the supporter 14 and the two-axis rotation unit 15 retract downward not so as to interfere therewith in the height direction.

The measuring unit 1S is disposed above the horizontal plane SF including the clamping axis CL1. Specifically, the measuring unit 1S includes: a support arm 1S1 that extends in the radial direction with one end portion supported by the support column 711 of the index unit 7; and a sensor 182 attached to a front end that is the other end of the support arm 1S1. The sensor 1S2 is, for example, a photoelectric sensor that detects the presence or absence of an object by light. The sensor 1S2 is configured to be able to be moved independently in the X, Y, and Z axis directions by an XYZ-axis driving unit 1S3 provided on the support arm 1S1 (see arrows DR4 to DR6). The sensor 182 detects the presence or absence of a cut wire on the horizontal plane SF at a position directly below the sensor 1S2.

As shown in FIG. 12, the bending control unit 935 of the control unit 93 controls the operation of the X-axis driving unit MX, the Y-axis driving unit MY, the Z-axis driving unit MZ, the supporter driving unit M14, the inner wheel driving unit M151, the outer wheel driving unit M152, and the XYZ-axis driving unit 13 of the measuring unit 1S. When the sensor 182 detects a cut wire, it outputs the detection information to the control unit 93. When the measurement determination unit 933 of the control unit 93 receives the detection information from the sensor 182, it stops the outer wheel driving unit M152.

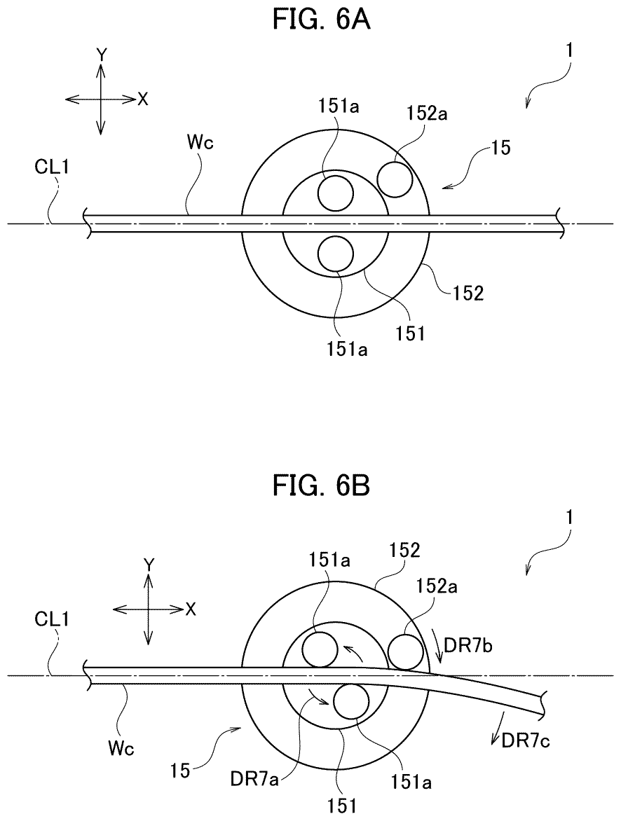

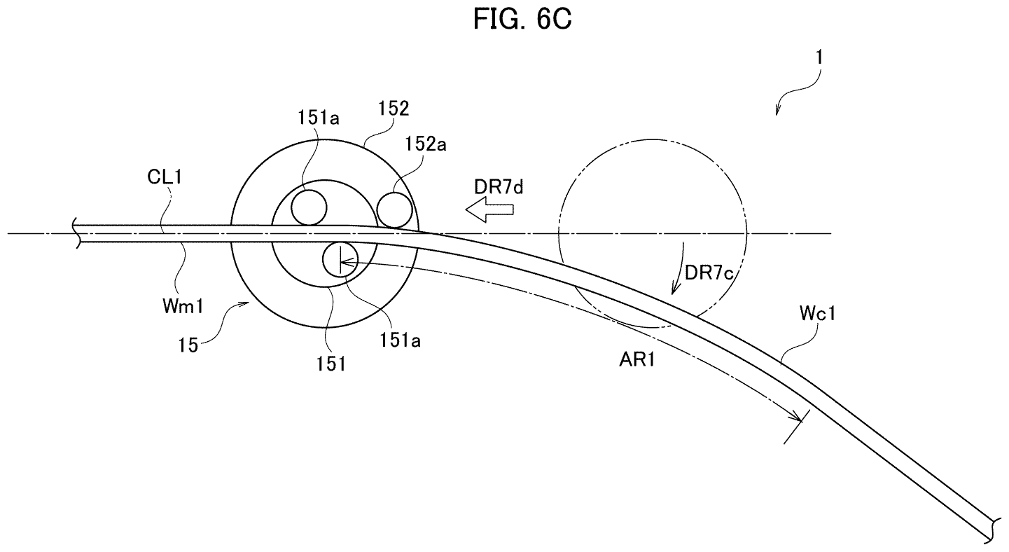

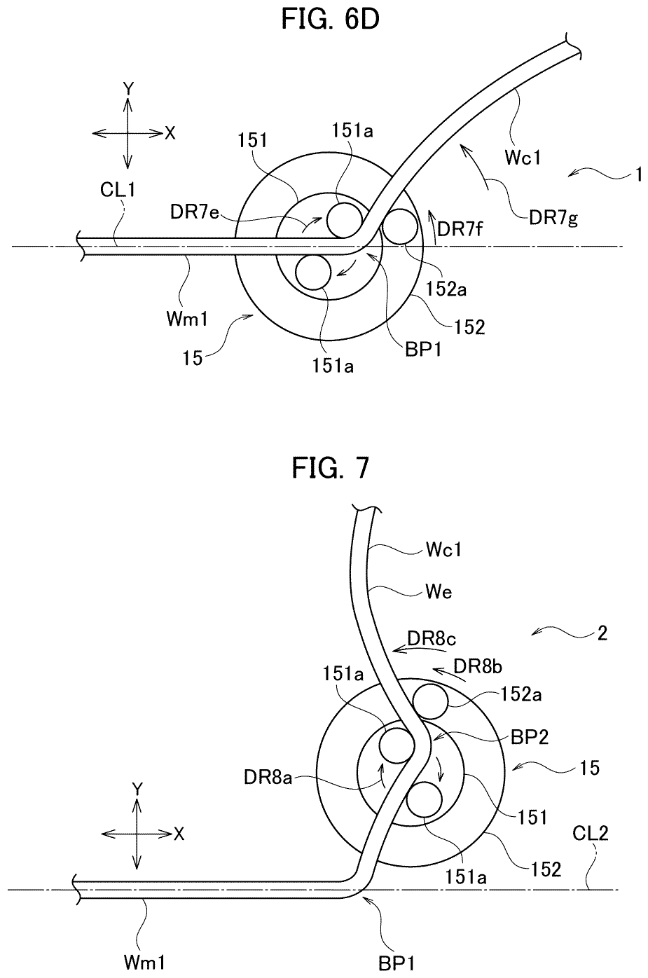

The above-described first station apparatus 1 subjects the cut wire Wc gripped by the gripper 721 to what is called roll bending to shape a curved portion Wc1 at a part on the front end side and to further form a bent portion BP1 at the base end portion of the curved portion Wc1. This process will be described in detail with reference to FIGS. 6A to 6D.

FIG. 6A is a top view showing the first stage in the process of the first station apparatus 1. FIG. 6B is a top view showing the second stage in the process of the first station apparatus 1. FIG. 6C is a top view showing the third stage in the process of the first station apparatus 1. FIG. 6D is a top view showing the fourth stage in the process of the first station apparatus 1.

In the first stage shown in FIG. 6A, in a state in which the supporter 14 and two-axis rotation unit 15 retract below on the Z axis, the index table 71 rotates to move the cut wire Wc to the first station position. The pair of inner pins 151a of the two-axis rotation unit 15 are positioned opposite each other in the Y axis direction, and the outer pin 152a is positioned above the cut wire Wc in FIG. 6A. The supporter 14 and two-axis rotation unit 15 then move to a predetermined position close to the front end of the cut wire Wc and move up. As a result, the cut wire Wc is positioned between the pair of inner pins 151a. The supporter 14 is on the index table 71 side of the two-axis rotation unit 15 and holds the cut wire Wc.

In the second stage shown in FIG. 6B, the operation of the inner wheel driving unit M151 causes the inner rotation unit 151 to rotate counterclockwise (see an arrow DR7a) to clamp and hold the cut wire Wc. Then, the operation of the outer wheel driving unit M152 causes the outer rotation unit 152 to rotate clockwise (see an arrow DR7b). This causes the outer pin 152a to bend the cut wire Wc downward in FIG. 6B with the inner pin 151a closer to the outer pin 152a as the fulcrum (see an arrow DR7c). Furthermore, the supporter 14 decreases the clamping force to an extent that it can slide relative to the cut wire Wc. Then, as shown in FIG. 6C, the two-axis rotation unit 15 moves parallel to the X-axis toward the index table 71 and stops at a predetermined position (see an arrow DR7d). As a result, a curved portion Wc1 is formed in the cut wire Wc over a range AR1 where the two-axis rotation unit 15 has moved parallel to the X-axis. The linear portion on the index table 71 side that is not the curved portion Wc1 is defined as an arm portion Wm1.

The bending control unit 935 then releases the bending by the outer pin 152a and the gripping by the inner pin 151a to move down the two-axis rotation unit 15. The bending control unit 935 subsequently rotates and moves the outer pin 152a downward in FIG. 6C relative to the cut wire Wc. Then, the bending control unit 935 moves up the two-axis rotation unit 15 again, and as shown in FIG. 6D, rotates the pair of inner pins 151a clockwise by operation of the inner wheel driving unit M151 to grip the arm portion Wm1 of the cut wire Wc (see an arrow DR7e). Thereafter, operation of the outer wheel driving unit M152 rotates the outer pin 152a counterclockwise (see an arrow DR7f) to bend the curved portion Wc1 upward in FIG. 6D (see an arrow DR7g).

When the curved portion Wc1 is bent to predetermined position, it is detected by the sensor 1S2 disposed above. When the sensor 182 detects the curved portion Wc1, it sends out a detection signal to the control unit 93. The measurement determination unit 933 of the control unit 93 receives this detection signal and stops the outer wheel driving unit M152.

In this way, the cut wire Wc is made into a bent wire Wd. The bent wire Wd includes: a bent portion BP1, which is formed by the first station apparatus 1 at the end portion of the curved portion Wc1 on the index table 71 side; and a curved portion Wc1, which is bent by the first station apparatus 1 at a predetermined angle at the bent portion BP1. In response to an instruction from the bending control unit 935, the supporter 14 and the two-axis rotation unit 15 retracts downward, and the bent wire Wd becomes movable to the second station position. Here, T1 is defined as the time from when the cut wire Wc moves to the first station position to when the two-axis rotation unit 15 completely retracts downward.

After the control unit 93 stops the index table 71 for a time that exceeds at least the time T1, it rotates the index table 71 by 60° clockwise in FIG. 3. This moves the bent wire Wd gripped by the gripper 721 to the second station position. At the station position, the second station apparatus 2 subjects the bent wire Wd to two-dimensional bending. In the following description, for the convenience of avoiding complication of reference numerals and characters, the reference numerals and characters of the members of the second station apparatus 2 will be described with the reference numerals and characters of the members of the first station apparatus 1.

As shown in FIG. 7, the bending control unit 935 of the control unit 93 moves the two-axis rotation unit 15, having moved down, in the X-axis and Y-axis directions to a predetermined position away from the clamping axis CL2. The predetermined position is the center of the curved portion Wc1. As in the two-dimensional bending in the first station position, the bending control unit 935 moves up the two-axis rotation unit 15, and operates the inner wheel driving unit M151 to rotate the inner rotation unit 151 clockwise to clamp the curved portion Wc1 with the pair of inner pins 151a (see an arrow DR8a). Then, the bending control unit 935 operates the outer wheel driving unit M152 to rotate the outer rotation unit 152 counterclockwise (see an arrow DR8b) to cause the outer pin 152a to bend a portion on the front end side in the curved portion Wc1 towards the index table 71 side (see an arrow DR8c).

When the portion on the front end side in the curved portion Wc1 is bent to a predetermined position, it is detected by the sensor 182 disposed above. When the sensor 1S2 detects the curved portion Wc1, it sends out a detection signal to the control unit 93, and the measurement determination unit 933 of the control unit 93 receives this detection signal and stops the outer wheel driving unit M152. As a result, the bent wire Wd is made by the second station apparatus 2 into the bent wire We in which a bent portion BP2 is formed at the central position of the curved portion Wc1.

Next, the two-axis rotation unit 15 is retracted downward in response to an instruction from the bending control unit 935, and the bent wire We becomes movable to the third station position. T2 is defined as the time from when the bent wire Wd moves to the second station position to when it becomes movable to the third station position as the bent wire We.

After the synchronization unit 932 of the control unit 93 stops the index table 71 for a time that exceeds at least the longer of the time T1 and the time T2, it rotates the index table 71 clockwise by 60° in FIG. 3. As a result, the bent wire We gripped by the gripper 721 moves to the third station position. At the third station position, the third station apparatus 3 subjects the bent wire We to two-dimensional bending. In the description of third station apparatus 3, for the convenience of avoiding complication of reference numerals and characters, the reference numerals and characters of the members of the third apparatus 3 will be described with the reference numerals and characters of the members of the first station apparatus 1.

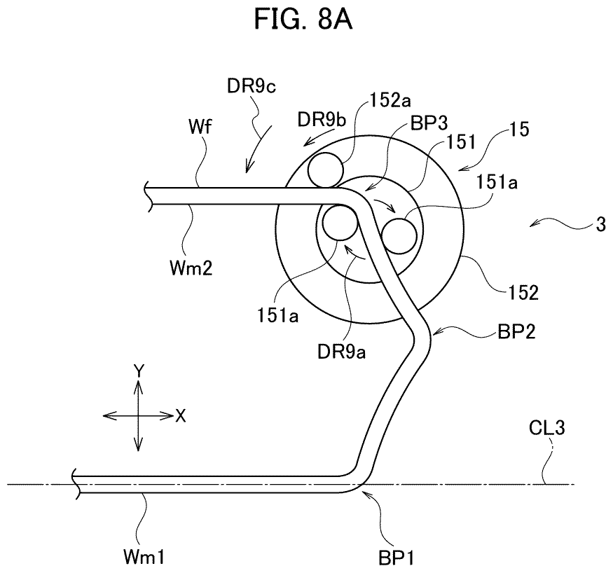

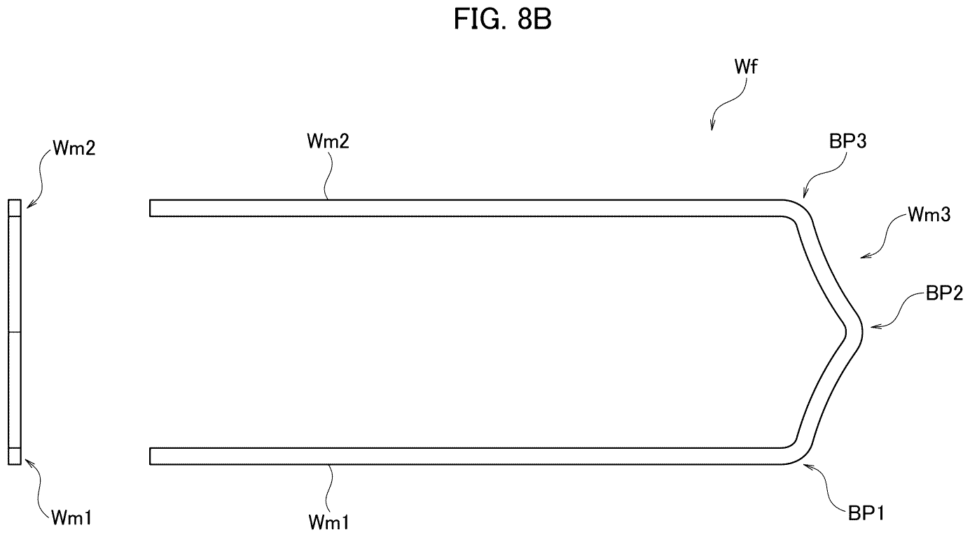

As shown in FIG. 8A, the bending control unit 935 moves the two-axis rotation unit 15, having moved down, in the X-axis direction and the Y-axis direction to a position that: corresponds to the bent portion BP1 on the X-axis; and is a distance away from the bent portion BP1 on the Y-axis, the distance being twice the distance between the bent portion BP1 and the bent portion BP2. This position corresponds to end portion on the front end side of the curved portion Wc1 in the bent wire We. As in the two-dimensional bending at the first station position, the bending control unit 935 moves up the two-axis rotation unit 15, and operates the inner wheel driving unit M151 to rotate the inner rotation unit 151 clockwise to clamp the curved portion Wc1 with the pair of inner pins 151a (see an arrow DR9a). Next, the bending control unit 935 operates the outer wheel driving unit M152 to rotate the outer rotation unit 152 counterclockwise (see an arrow DR9b). The outer pin 152a rotating in this manner bends the linear portion on the front end side relative to the curved portion Wc1 (hereinafter, arm portion Wm2) into a predetermined bending angle (see an arrow DR9c). In this example, the arm portion Wm2 is parallel to the arm portion Wm1.

When the outer pin 152a rotates to form the bent portion BP3 and bend the arm portion Wm2 to a predetermined position, the sensor 182 disposed above detects the arm portion Wm2. When the sensor 182 detects the arm portion Wm2, it sends out a detection signal to the control unit 93, and the measurement determination unit 933 of the control unit 93 receives this detection signal and stops the outer wheel driving unit M152.

In this way, the bent wire We is made into the bent wire Wf shown in FIG. 8B by the third station apparatus 3. FIG. 8B is a plan view showing the bent wire Wf after processing by the third station apparatus 3. The bent wire Wf has a gate-type shape with the parallel arm portions Wm1 and Wm2 and a connecting portion Wm3 that connects the bent portions BP1 and BP3 respectively located at one end portions of arm portions. After the bending control unit 935 stops the outer wheel driving unit M152, it retracts the two-axis rotation unit 15 downward. This causes the bent wire Wf to become movable to the fourth station position. T3 is defined as the time from when the bent wire We moves to the third station position to when it becomes movable to the fourth station position as the bent wire Wf.

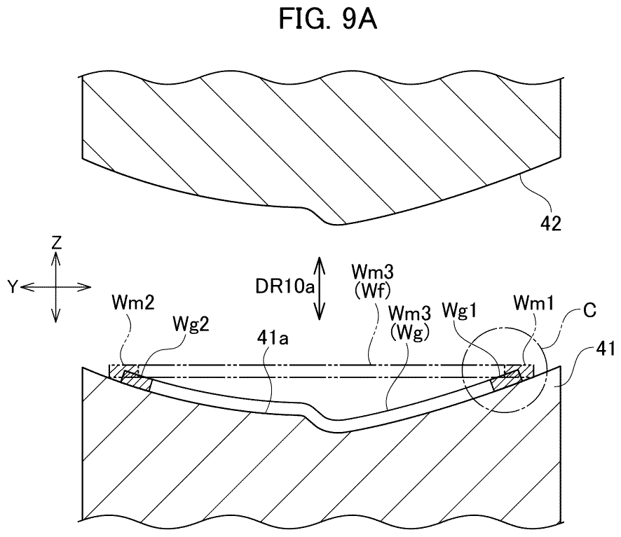

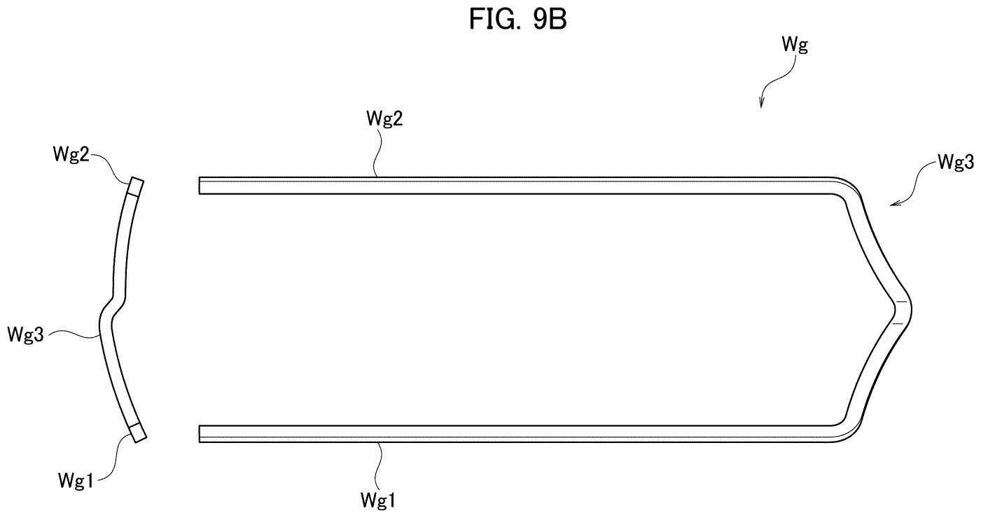

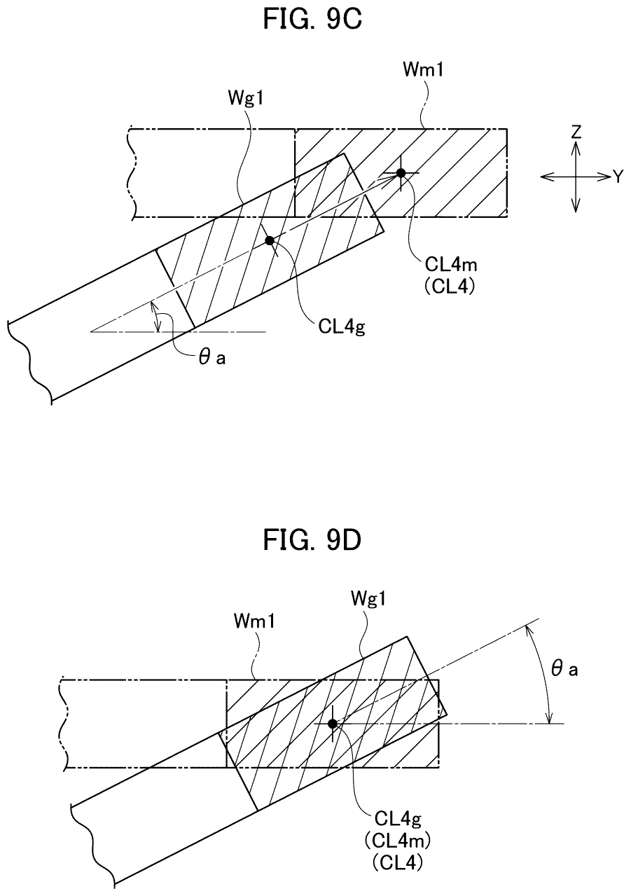

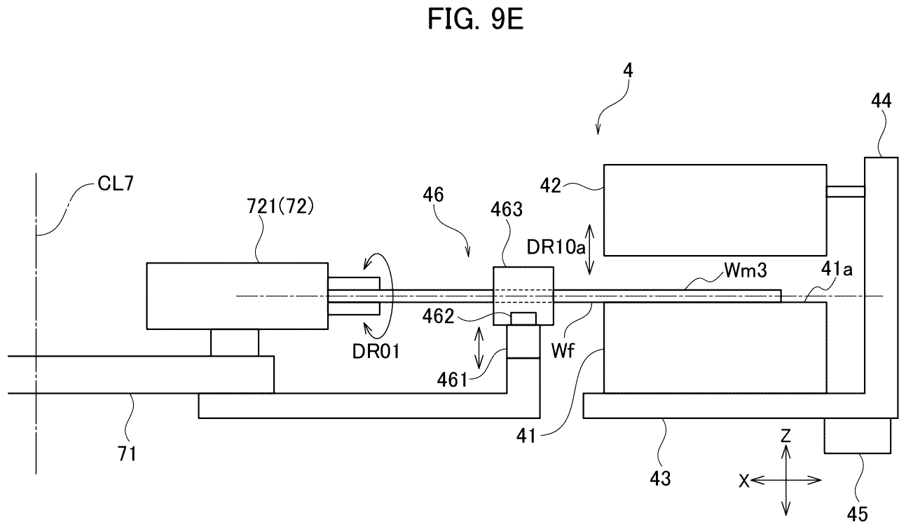

At the fourth station position, three-dimensional pressing is performed by the fourth station apparatus 4 under the control of the press control unit 936 of the control unit 93. The configuration and operation of the fourth station apparatus 4 will be described with reference to FIGS. 9A to 9E. FIG. 9A is a diagram showing pressing in the fourth station apparatus 4. FIG. 9B is a plan view showing a hairpin conductor Wg obtained by processing in the fourth station apparatus 4. FIG. 9C is a diagram showing the deformation of the arm portion Wm1 of the bent wire Wf in processing in the fourth station apparatus 4, and is a diagram corresponding to a portion C shown in FIG. 9A. FIG. 9D is a diagram showing the operation corresponding to the deformation of the arm portion Wm1. FIG. 9E is a side view of the fourth station apparatus 4.

As shown in FIG. 9E, the fourth station apparatus 4 includes a tool table 43, a press driving unit 44, and an XYZ-axis driving unit 45 (see FIG. 13). A lower tool 41 is detachably attached to the tool table 43. An upper tool 42 is detachably connected to the press driving unit 44.

The tool table 43 and the press driving unit 44 is configured to be movable in the directions of the X, Y and Z axes by the XYZ-axis driving unit 45. The upper tool 42 is moved up and down relative to the lower tool 41 by the press driving unit 44 (see an arrow DR10a). When the upper tool 42 is moved down, it subjects the connecting portion Wm3 of the bent wire Wf, which has been set between the upper tool 42 and the upper surface 41a of the lower tool 41 (see FIG. 9A), to three-dimensional pressing.

As shown in FIG. 9E, the fourth station apparatus 4 includes an auxiliary clamping unit 46 disposed between the tool table 43 and the gripper 721 in the X-axis direction. The auxiliary clamping unit 46 moves up and down by operation of the Z-axis driving unit 461, and loosely grips the arm portion Wm1 with a pair of clampers 463 that move toward and away from each other in the Y-axis direction. The gripping and releasing operation of the pair of clampers 463 on the arm portion Wm1 is performed by the clamping operation unit 462.

The synchronization unit 932 of the control unit 93 rotates the index table 71 by 60° clockwise in FIG. 3 when the longest time among times T1 to T3 elapses from when the bent wire We is moved to the third station apparatus 3. When the bent wire Wf moves to the fourth station position, the operation of the XYZ-axis driving unit 45 moves the tool table 43 to a predetermined position. In this state, as shown in FIG. 9A, the press surface of the upper surface 41a of the lower tool 41 is a predetermined curved surface that is hollowed out downward. Accordingly, the bent wire Wf, indicated by a dash-dot-dot line, has outer lower edges of the arm portions Wm1 and Wm2 in contact with the upper surface 41a of the lower tool 41, and is placed in a horizontal position.

Before the upper tool 42 moves down to perform the pressing, the clamper 463 of the auxiliary clamping unit 46 loosely holds the arm portion Wm1, and the gripper 721 releases its grip on the arm portion Wm1. The upper surface 41a of the lower tool 41 is made into a surface hollowed out downward. As a result, when the upper tool 42 moves down to perform the pressing, the pair of arm portions Wm1 and Wm2 move downward while approaching each other in the Y-axis direction, as shown also in FIG. 9C, so that the arm portions Wm1 and Wm2 are positioned slightly downward and become arm portions Wg1 and Wg2 inclined by an angle θa so that their outer edges are higher. Therefore, the gripper 721 follows the inclination of the arm portion Wg1 caused by the plastic deformation of the bent wire Wf due to the pressing, to be inclined by an angle θa in the same direction around the clamping axis CL4.

As described above, the arm portion Wg1 is an arm portion formed such that the arm portion Wm1 is inclined and shifted downward and inward. After the pressing is performed, the press control unit 936 operates the XYZ-axis driving unit 45 to move the tool table 43 three-dimensionally so that the center position CL4g of the arm portion Wg1 coincides with the center position CL4m of the bent wire Wf, which is the bent wire before the pressing. This positions the center position CL4g onto the clamping axis CL4 with the arm portion Wg1 inclined by angle θa, as shown in FIG. 9D.

Next, the auxiliary clamping unit 46 releases the grip of the arm portion Wg1 and the gripper 721 rotates its gripping surface by an angle θa around the clamping axis CL4 to grip the arm portion Wg1. This makes the hairpin conductor Wg movable to the fifth station position. T4 is defined as the time from when the bent wire Wf moves to the fourth station position to when it becomes movable to the fifth station position as the hairpin conductor Wg.

The three-dimensional pressing by the fourth station apparatus 4 makes the bent wire Wf into a hairpin conductor Wg shown in FIG. 9B. The hairpin conductor Wg has a gate-type shape with the pair of arm portions Wg1 and Wg2 extending in the X-axis direction and the connecting portion Wg3 connecting between one end portions of the arm portions Wg1 and Wg2.

The synchronization unit 932 of the control unit 93 rotates the index table 71 by 60° clockwise in FIG. 3 when the longest time among times T1 to T4 elapses from when the bent wire Wf is moved to the fourth station apparatus 4. The hairpin conductor Wg moves the to fifth station position.

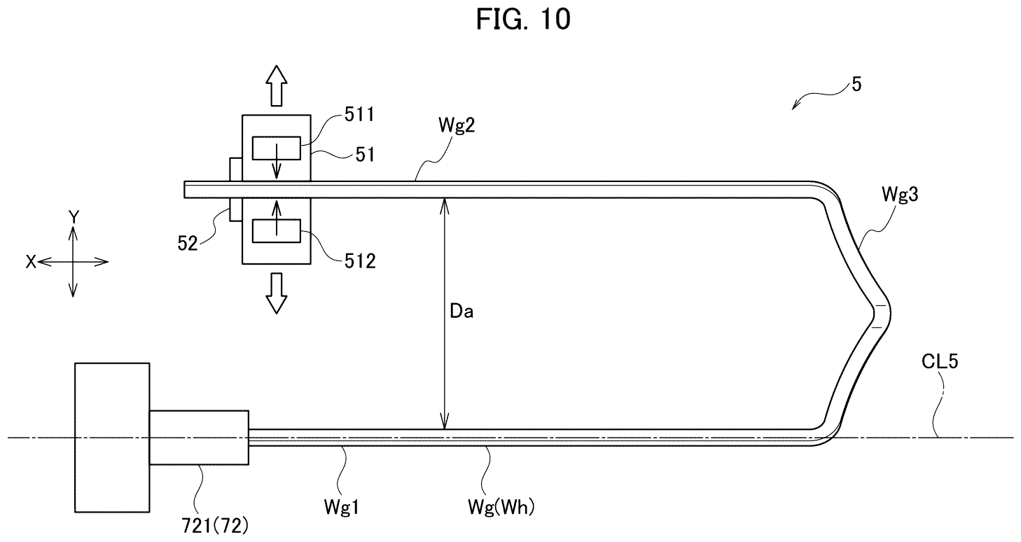

The fifth station apparatus 5 includes a correction unit 51 as shown in FIG. 10. The correction unit 51 is moved in the X-axis direction and the Z-axis direction by the XZ driving unit 52. The correction unit 51 also includes contacts 511 and 512 that can move from a distant position in the Y-axis direction and come into contact with each other to grip the arm portion Wg2. The correction unit 51 is normally in a retracted position below the hairpin conductor Wg. When the measurement determination unit 933 of the control unit 93 determines that correction processing is necessary for the hairpin conductor Wg, the correction unit 51 moves up and operates the contacts 511 and 512 to further bend and deforms the arm portion Wg2 in the Y-axis direction. This series of operation is controlled by the correction operation unit 937 based on the determination, made by the measurement determination unit 933, that correction processing is necessary.

The correction operation at the fifth station position will be specifically described. When the hairpin conductor Wg moves to the fifth station position, the camera 712 captures an image of the hairpin conductor Wg in a plan view and sends out the captured image to the control unit 93. The measurement determination unit 933 of the control unit 93 detects the state in positions of the pair of arm portions Wg1 and Wg2 of the hairpin conductor Wg based on the image and make a pass/fail determination. In detail, the measurement determination unit 933 measures the internal dimension Da based on the image at a position that is a predetermined distance away from the front end of the pair of arm portions Wg1 and Wg2 toward the connecting portion Wg3, compares this internal dimension Da with the dimensional tolerance range specified in the specifications for the hairpin conductor Wg, and makes a pass/fail determination in n which the internal dimension Da passes when it is within the tolerance range.

When the measurement determination unit 933 determines that the internal dimension Da is within the tolerance range and passes, the gripper 721 releases its grip and discharges the hairpin conductor Wg to the non-defective product receiver of the discharge unit 92. When the measurement determination unit 933 determines that the internal dimension Da is below or exceeds the tolerance range, the correction operation unit 937 performs correction processing. As shown in FIG. 10, the correction processing is performed by forcibly moving and deforming the arm portion Wg2 of the hairpin conductor Wg in the Y-axis direction by the contacts 511 and 512, in which the arm portion Wg1 of the hairpin conductor Wg is gripped by the gripper 721.

The hairpin conductor Wg that has been subjected to the correction processing is defined as the hairpin conductor Wh. The camera 712 captures a planar image of the hairpin conductor Wh, and the measurement determination unit 933 makes the pass/fail determination on the hairpin conductor Wh based on the obtained planar image. When the hairpin conductor Wh is determined to pass by the measurement determination unit 933, it is discharged to the non-defective product receiver of the discharge unit 92. When the hairpin conductor Wh is determined to fail because the internal dimension Da is outside the tolerance range, the hairpin conductor Wh is discharged to the defective product receiver of the discharge unit 92. The time T5 of the correction processing operation of the fifth station apparatus 5 is set so as not to exceed the longest time among times T1 to T4.

As described above in detail, in the wire processing apparatus 91, which is a manufacturing apparatus for hairpin conductors, the two-dimensional bending for cut wire is divided into a plurality of processes. The plurality of two-dimensional bending processes after the division and the three-dimensional pressing process are allocated to a plurality of station positions (n positions: n is a positive integer of 3 or more) disposed at equal angle pitch θp on a circumference. At the station positions, the station apparatuses for performing individual processing are respectively disposed. There is also the index table 71 including the group of grippers 72 at a predetermined angle pitch θp for gripping rectangular wires, each having a predetermined length, which are cut in the pre-processing apparatus group 80 as workpieces. The index table 71 is intermittently rotated at an angle pitch θp so that the group of grippers 72 stops at the corresponding station positions. In the stop period of the intermittent rotation of the index table 71, the cut wire with a predetermined length is gripped at one station position out of the n positions. In the same period, the (n-1) processes such as processing are simultaneously performed on the workpieces at the (n-1) station positions. Therefore, the wire processing apparatus 91 can subject different workpieces to corresponding bending and pressing at the same time, improving productivity.

The number of division of the two-dimensional bending process is set so as to minimize the difference between the longest and shortest times among the times T1 to T3 respectively required for processing in the divided processes and the time T4 required for the three-dimensional pressing. When the time required for the three-dimensional pressing is significantly long, the three-dimensional pressing may be divided. When the time required for the two-dimensional bending is significantly short, a plurality of bending processes may be combined into one station.

As described above, one aspect of the manufacturing apparatus for the hairpin conductor of the present disclosure is a manufacturing apparatus 91 for a hairpin conductor including: an index table 71 configured to intermittently rotate around a perpendicularly extending rotation axis CL7; a plurality of grippers 721 to 726 attached to the index table 71 at a predetermined angle pitch θp around the rotation axis CL7, the grippers 721 to 726 each being configured to be capable of gripping a linear cut wire Wc in a radially extending horizontal position, the linear cut wire Wc having a predetermined length; and a plurality of station apparatuses 1 to 5 installed around the index table 71 at the angle pitch θp around the rotation axis CL7, the station apparatuses being configured to process the cut wire Wc, gripped by the gripper 721, in stages into a hairpin conductor Wg having a three-dimensional shape, wherein the plurality of station apparatuses 1 to 5 include bending apparatuses 1 to 3 and a pressing apparatus 4, and an installation order is set along a rotation direction of the index table 71.

As a result, the one aspect of the manufacturing apparatus 91 for the hairpin conductor can subject a plurality of workpieces to a plurality of bending and pressing at the same time, shortening the takt time and achieving high productivity.

The bending apparatuses 1 to 3 may include a plurality of two-dimensional bending apparatuses.

This can reduce the difference between processing times, resulting in a shortened stop time of the intermittent rotation of the index table 71 and a further enhanced productivity of the one aspect of the manufacturing apparatus 91 for the hairpin conductor.

Furthermore, there may be a configuration such that: the processing of the pressing apparatus 4 shapes the hairpin conductor Wg having a three-dimensional shape; and the plurality of station apparatuses 1 to 5 include a correction unit 51 after the pressing apparatus 4 in the rotation direction, the correction unit 51 subjecting the hairpin conductor Wg shaped by the pressing apparatus 4 to correction processing.

As a result, the one aspect of the manufacturing apparatus 91 for the hairpin conductor can improve the usage rate and achieve higher productivity.

Furthermore, there may be a configuration such that: in pressing by the pressing apparatus 4, the gripper 721 releases its grip on the arm portion Wm1 of the cut wire Wc to be pressed; and after pressing, the pressing apparatus 4 moves the shaped hairpin conductor Wg to a position where the gripper 721 can grip one of the pair of arms Wg1 of the hairpin conductor Wg.

As a result, the hairpin conductor Wg manufactured by the one aspect of the manufacturing apparatus 91 for the hairpin conductor has less distortion and is highly accurate.

On the other hand, one aspect of a manufacturing method for a hairpin conductor of the present disclosure is a manufacturing method for a hairpin conductor, including: bending apparatuses 1 to 3 and a pressing disposing a apparatus 4 around an index table 71 at a predetermined angle pitch θp along a rotation direction of the index table 71, the bending apparatuses 1 to 3 and the pressing apparatus 4 being configured to process a cut wire Wc in stages into a hairpin conductor Wg having a three-dimensional shape, the index table 71 being configured to intermittently rotate; gripping, by a plurality of grippers 721 to 726, a linear cut wire Wc having a predetermined length in a radially extending horizontal position, the grippers 721 to 726 being attached to the index table 71 at the angle pitch θp; performing, by the bending apparatuses 1 to 3, two-dimensional bending of the cut wire Wc gripped by the gripper 721 in a stop period of intermittent rotation of the index table 71; and shaping, by the pressing apparatus 4, the cut wire Wc into the hairpin conductor Wg having a three-dimensional shape in a next stop period, the cut wire Wc having been subjected to the bending.

Therefore, in one aspect of a manufacturing method for a hairpin conductor, a plurality of workpieces can be subjected to a plurality of bending and pressing processes at the same time, resulting in high productivity.

Furthermore, there may be a configuration such that: the two-dimensional bending is divided into a plurality of processes; a plurality of bending apparatuses 1 to 3 respectively corresponding to the plurality of divided processes are disposed at a predetermined angle pitch θp; and the two-dimensional performed by the plurality of bending apparatuses 1 to 3.

This can reduce the difference between processing times, resulting in a shortened stop time of the intermittent rotation of the index table 71 and a further enhanced productivity with the one aspect of the manufacturing method for the hairpin conductor.

Furthermore, after the pressing by the pressing apparatus 4, the hairpin conductor Wg shaped by the pressing may be subjected to correction processing.

As a result, the one aspect of the manufacturing method for the hairpin conductor can improve the usage rate and achieve higher productivity.

Furthermore, there may be a configuration such that: in pressing of the pressing apparatus 4, the gripper 721 releases its grip of the cut wire Wc to be pressed; and after the pressing, the shaped hairpin conductor Wg is moved to a position where the gripper 721 can grip one of the pair of arms Wg1 of the hairpin conductor Wg.

As a result, the hairpin conductor Wg manufactured by one aspect of the manufacturing method for the hairpin conductor has less distortion and is highly accurate.

The embodiment of the present invention is not limited to the above-described configuration, and may be a modified example without departing from the spirit and scope of the present invention.

The disclosure of the present application is related to the subject matter described in Japanese Patent Application No. 2022-092381 filed on Jun. 7, 2022, the entire disclosure of which is incorporated herein by reference.

1. A manufacturing apparatus for a hairpin conductor comprising:
an index table configured to intermittently rotate around a perpendicularly extending rotation axis;
a plurality of grippers attached to the index table at a predetermined angle pitch around the rotation axis, the grippers each being configured to be capable of gripping a linear cut wire in a radially extending horizontal position, the linear cut wire having a predetermined length; and
a plurality of station apparatuses installed around the index table at the angle pitch around the rotation axis, the station apparatuses being configured to process the cut wire, gripped by the grippers, in stages to shape the cut wire into a hairpin conductor.

2. The manufacturing apparatus for the hairpin conductor according to claim 1, wherein the at least one bending apparatus includes a plurality of two-dimensional bending apparatuses.

3. The manufacturing apparatus for the hairpin conductor according to claim 1, wherein each gripper rotatably grips the cut wire around a central axis of the cut wire.

4. The manufacturing apparatus for the hairpin conductor according to claim, wherein
the hairpin conductor having a three-dimensional shape is shaped by processing of the pressing apparatus, and
the plurality of station apparatuses include a correction unit configured to perform correction processing on the hairpin conductor shaped by the pressing apparatus, the correction unit disposed after the pressing apparatus in the rotation direction.

5. The manufacturing apparatus for the hairpin conductor according to claim 1, wherein each gripper releases grip of the cut wire to be pressed in pressing of the pressing apparatus, and the pressing apparatus moves the shaped hairpin conductor to a position after pressing, the position being where the gripper can grip one of a pair of arms of the hairpin conductor.

6. A manufacturing method for a hairpin conductor, comprising:
disposing at least one bending apparatus and a pressing apparatus around an index table at a predetermined angle pitch along a rotation direction of the index table, the bending apparatus and the pressing apparatus being configured to process a cut wire in stages into a hairpin conductor having a three-dimensional shape, the index table being configured to intermittently rotate;
gripping, by one of a plurality of grippers, a linear cut wire having a predetermined length in a radially extending horizontal position, the grippers being attached to the index table at the angle pitch;
performing, by the bending apparatus, two-dimensional bending of the cut wire gripped by the grippers in a stop period of intermittent rotation of the index table; and
shaping, by the pressing apparatus, the cut wire into the hairpin conductor having a three-dimensional shape in a next stop period, the cut wire having been subjected to the bending.

7. The manufacturing method for the hairpin conductor according to claim 6, further comprising:
dividing the two-dimensional bending into a plurality of processes, and disposing a plurality of bending apparatuses respectively corresponding to the plurality of divided processes at the predetermined angle pitch; and
performing, by the plurality of bending apparatuses, the two-dimensional bending.

8. The manufacturing method for the hairpin conductor according to claim 6, further comprising performing correction processing on the hairpin conductor having been shaped by pressing by the pressing apparatus after the pressing.

9. The manufacturing method for the hairpin conductor according to claim 6, further comprising, in pressing of the pressing apparatus:
(a): positioning the cut wire;
(b): releasing grip by the gripper after (a);
(c): performing pressing after (b);
(d): moving the shaped hairpin conductor to a position after (c), the position being where the gripper can grip one of a pair of arms of the hairpin conductor; and
(e): gripping, by the gripper, one of the arms after (d).

10. The manufacturing apparatus for the hairpin conductor according to claim 1, wherein the plurality of station apparatuses include at least one bending apparatus and a pressing apparatus, and an installation order is set along a rotation direction of the index table.
